(19) United States
(12) Patent Application Publication
(10) Pub. No.: US 2021/0268400 A1
(43) Pub. Date: Sep. 2, 2021

(54) IMPROVEMENTS IN SUPERCRITICAL CARBON DIOXIDE EXTRACTION

(71) Applicant: GREEN MILL SUPERCRITICAL, INC., Pittsburgh, PA (US)

(72) Inventor: Jeremy DIEHL, Pittsburgh, PA (US)

(73) Assignee: GREEN MILL SUPERCRITICAL, INC., Pittsburgh, PA (US)

(21) Appl. No.: 17/255,351

(22) PCT Filed: Jun. 24, 2019
(86) PCT No.: PCT/US2019/038722

§ 371 Date: Dec. 22, 2020

Related U.S. Application Data
(60) Provisional application No. 62/688,818, filed on Jun. 22, 2018.

(51) Int. Cl. B01D 11/02

(52) U.S. Cl. CPC B01D 11/0203; B01D 11/028; B01D 11/0207

(57) ABSTRACT

Improvements in extraction techniques are described. The improved extraction is provided by an outlet flow controller nut which enhances the efficiency of the collection of compounds as they are extracted from supercritical CO₂. An improved extraction apparatus which includes precise computer controls based on the properties of supercritical CO₂ is also described. The extraction apparatus enables a human operator to extract compounds from organic material with a minimum of intervention and with greater precision that conventional extraction apparatus, which often requires frequent adjustment and yields imprecise results.

### CROSS-REFERENCE TO RELATED APPLICATIONS

This application is a national stage entry under 35 U.S.C. § 371 of World Intellectual Property Organization Application Serial No. PCT/US2019/038722, which claims priority to and benefit of U.S. Provisional Application Ser. No. 62/688,818, filed Jun. 22, 2018, all of which are incorporated herein by reference in their entirety.

### BACKGROUND OF THE INVENTION

Recently, there has been increased interest by consumers in the extraction of various organic compounds from plants for human use and consumption. Conventionally, extraction has been performed using various organic solvents such as perchloroethylene, ethyl alcohol, butane, methylene chloride, and hexane which are selected to take up the desired organic compounds. While effective, these compounds have drawbacks, such as leaving trace amounts of the solvent in the extracted product.

Supercritical carbon dioxide (known as “sCO₂” and “supercritical CO₂”) is a fluid state of carbon dioxide that occurs when CO₂ is maintained above its critical temperature and critical pressure, known as the “critical point.” This critical point in the phase diagram of CO₂ is important because it is here that the phase boundaries between liquid and gas vanish, and the CO₂ behaves as a supercritical fluid. Supercritical fluids such as sCO₂ are unique because they exhibit some properties which are like a gas (i.e., low viscosity than a gas) and some properties which are like a liquid (i.e., higher density than liquid).

Supercritical CO₂ also has its own unique properties that are important to the extraction industry. CO₂ is generally inert and does not react with the compounds that it is used to extract, which is important in maintaining the safety, quality, flavors, and scents of organic compounds which are used by humans. CO₂ is also easy to manage during extraction because after it has finished forming a solution with the extracted compounds, it can be depressurized below the critical point which causes the sCO₂ to change to gas and the extracted compounds to “drop out” of solution for easy collection. The now gaseous CO₂ is mostly clean and can be collected and easily recycled before being pumped again through new material to extract. CO₂ is also affordable and environmentally benign, which cannot be said for other prior art solvents.

The most important advantage of sCO₂ in extraction is that its affinity for dissolved compounds, especially oils and other valuable compounds which are found in organic plant matter, can be “tuned” by precisely controlling the temperature and pressure within the supercritical phase. This allows the sCO₂ to selectively act as a solvent for specific materials. However, prior art extraction techniques and devices that have employed sCO₂ have often failed to take advantage of this important property. These prior art techniques result in extracted product that is inconsistent and of poor quality. Prior art extraction devices are also inefficient in the amount of extract that is obtained from the plant matter and other raw material from which extracts are removed. The improvements of the invention are directed to overcome these drawbacks.

### BRIEF SUMMARY OF THE INVENTION

The invention includes several embodiments. In a first embodiment, the invention is an outlet flow controller nut which increases extraction efficiency. In a second embodiment, the invention is a collection vessel that collects compounds of interest suspended in sCO₂, and in some instances comprises the outlet flow controller nut. In a third embodiment, the invention is a method of operating an extraction apparatus with the aid of a digital computer. In a fourth embodiment, the invention is an extraction apparatus which may include the digital computer and outlet flow controller nut.

A brief summary of each of the several embodiments is below:
1. An outlet flow controller nut, comprising:
   a tubular body, comprising
      a first end of the tubular body that includes a connection for a first fluid collection port located in the upper portion of a collection vessel,
      a second end of the tubular body that includes an intake port on the top side of the tubular body,
      wherein the intake port on the top side of the tubular body causes fluids to flow up and over the outlet flow controller nut before the fluids are collected by flowing through the intake port.
2. The outlet flow controller nut of embodiment 1, wherein the connection is selected from the group consisting of threads, brazing, welding, compression fitting, rivet structures, adhesive, tape, gaskets, and combinations thereof.
3. The outlet flow controller nut of embodiment 1, wherein the tubular body has a cross-sectional profile selected from the group consisting of a circle, an ellipse, a square, a rectangle, a polygon, an irregular shape having no linear edges, and combinations thereof.
4. The outlet flow controller nut of embodiment 1, wherein the intake port has a profile selected from the group consisting of a circle, an ellipse, a square, a rectangle, a polygon, an irregular shape having no linear edges, and combinations thereof.
5. A collection vessel comprising:
   an outlet flow controller nut, comprising a tubular body, comprising
      a first end of the tubular body that includes a connection for a first fluid collection port located in an upper portion of a collection vessel,
      a second end of the tubular body that includes an intake port on the top side of the tubular body,
      wherein the intake port on the top side of the tubular body causes fluids to flow up and over the outlet flow controller nut before the fluids are collected by flowing through the intake port; and
   a second fluid collection port located in a lower portion of the collection vessel; and an inlet port.
6. A method of operating an extraction apparatus with the aid of a digital computer, comprising:
   providing the digital computer with instructions based on the thermodynamic properties of CO₂;
      wherein the instructions based on the thermodynamic properties of CO₂ are derived from the fundamental equation for the specific Helmholtz free energy,
   providing the digital computer with a database that includes the coefficient data usable in the fundamental equation for the specific Helmholtz free energy;
      wherein the coefficient data is specific to the thermodynamic properties of CO₂;
   wherein the digital computer causes the extraction apparatus to provide CO₂ in a supercritical state for extraction of compounds from a charge material, wherein the extracted compounds selectively extracted based on the temperature and pressure of the supercritical CO₂, which is monitored and adjusted by the digital computer at frequent intervals using the instructions and the coefficient data.
7. An extraction apparatus for the extraction of compounds from a charge material, comprising:
   a digital computer, which includes a processor and a non-transitory computer readable medium,
   wherein the non-transitory computer readable medium includes instructions based on the thermodynamic properties of CO₂ which are derived from the fundamental equation for the specific Helmholtz free energy,
   wherein the non-transitory computer readable medium includes a database that includes coefficient data usable in the fundamental equation for the specific Helmholtz free energy, and which is specific to the thermodynamic properties of CO₂, and
   wherein during operation, the extraction apparatus provides CO₂ in a supercritical state for extraction of compounds from a charge material,
   wherein during operation, the extraction apparatus selectively extracts desired compounds from the charge material based on the temperature and pressure of the supercritical CO₂, which is monitored and adjusted by the digital computer at frequent intervals using the instructions and the coefficient data.
8. The extraction apparatus of embodiment 7, further comprising a collection vessel, wherein an outlet flow controller nut is positioned within the collection vessel and is connected to a first fluid collection port.
9. The extraction apparatus of embodiment 7, further comprising a liquid displacement pump for the CO₂ which is controlled by the digital computer.
10. The extraction apparatus of embodiment 7, further comprising a temperature sensor and a pressure sensor, each of which transmit signals.
11. The extraction apparatus of embodiment 7, further comprising a heater that is controlled by the digital computer.
12. The extraction apparatus of embodiment 7, wherein the digital computer automatically calculates the density of the CO₂ which is based on the temperature and pressure of the CO₂ within each vessel of the extraction apparatus.
13. The extraction apparatus of embodiment 7, further comprising a phase monitor window which permits observation of the solubility of the charge material in the supercritical CO₂.
14. The extraction apparatus of embodiment 7, wherein the digital computer provides a user interface that permits a human operator to control the density of the supercritical CO₂ so as to extract desired compounds from the charge material.
15. The extraction apparatus of embodiment 7, wherein the digital computer further comprises saved parameters for each desired compound which is to be extracted from the charge material, and wherein the digital computer can operate the extraction apparatus using the saved parameters without the intervention of a human operator.
16. The extraction apparatus of embodiment 7, wherein the extraction apparatus comprises at least one collection vessel that can extract a compound by providing supercritical CO₂ at a pressure
17. The extraction apparatus of embodiment 7, wherein the extraction apparatus comprises more than one collection vessel, and wherein each collection vessel can independently extract a different compound by providing supercritical CO₂ at different pressures and/or temperatures.
18. The extraction apparatus of embodiment 7, wherein the extraction apparatus comprises a CO₂ recycle stage which removes compounds that were not extracted from the charge material from the CO₂ before returning the CO₂ to the chiller.
19. An extraction apparatus comprising:
   a supply of CO₂, a chiller, a liquid displacement pump, a heater, an extraction vessel, a collection vessel, a CO₂ recycle stage, and a digital computer, wherein the collection vessel includes an outlet flow controller nut.

### BRIEF DESCRIPTION OF THE SEVERAL VIEWS OF THE DRAWING

FIG. 1 is a depiction of the extraction process of the invention.

FIG. 2 is a depiction of the extraction apparatus of the invention.

FIG. 3 is a side, cross-sectional view of a collection vessel employing an outlet flow controller nut described herein.

FIG. 4 is a top plan view of a collection vessel employing an outlet flow controller nut described herein.

### DETAILED DESCRIPTION OF THE INVENTION

Before the present compositions and methods are described, it is to be understood that this invention is not limited to the particular processes, compositions, or methodologies described, as these may vary. It is also to be understood that the terminology used in the description is for the purpose of describing the particular versions or embodiments only, and is not intended to limit the scope of the present invention, which will be limited only by the appended claims. Unless defined otherwise, all technical and scientific terms used herein have the meaning commonly understood by one of ordinary skill in the art. Although any methods and materials similar or equivalent to those described herein can be used in the practice or testing of embodiments of the present invention, the preferred methods, devices, and materials are now described. All publications mentioned herein are incorporated by reference in their entireties. Nothing herein is to be construed as an admission that the invention is not entitled to antedate such disclosure by virtue of prior invention.

It must also be noted that as used herein and in the appended claims, the singular forms “a,” “an,” and “the” include plural references unless the context clearly dictates otherwise. Thus, for example, reference to “a combustion chamber” is a reference to “one or more combustion chambers” and equivalents thereof known to those skilled in the art, and so forth.

As used herein, the term “about” means plus or minus 10% of the numerical value of the number with which it is being used. Therefore, about 50% means in the range of 45%-55%.

As used herein, the term “may” means that the features or language that follows can be included or can be omitted from the overall process, machine, manufacture, composition of matter, or any other improvement thereof.

Throughout this specification, when terms are described in the singular, it is meant that the term encompasses both the singular element and plurality of the claim elements. For example, a description of “the extraction vessel” means that in some embodiments, there is a single extraction vessel, but that in other embodiments, there is at least one extraction vessel.

Outlet Flow Controller Nut

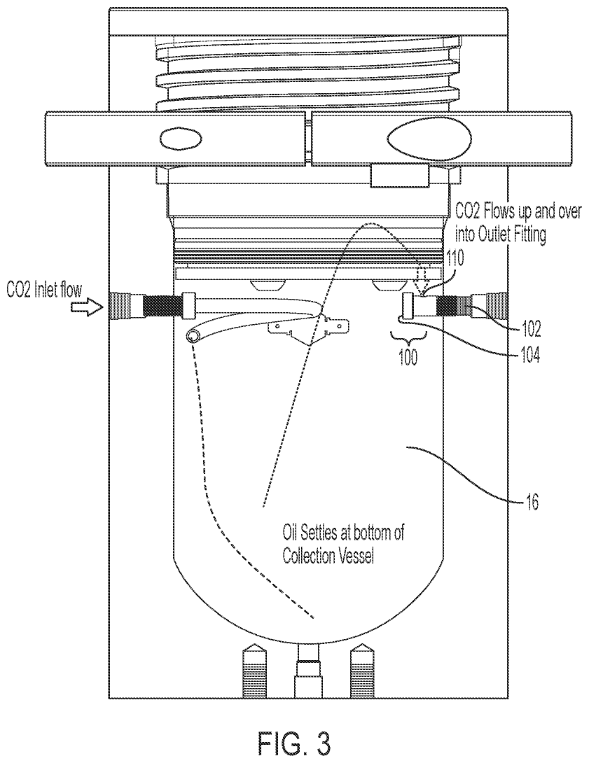

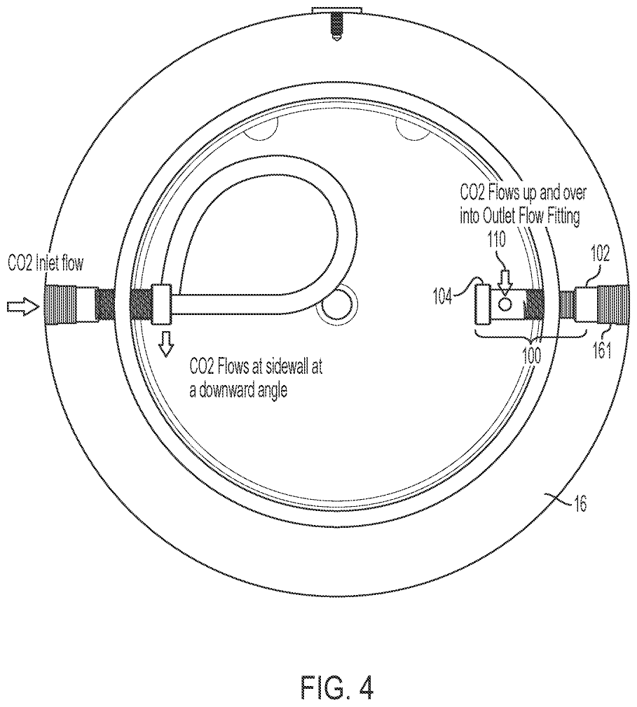

The inventive extraction apparatus includes an outlet flow controller nut 100 which is specially designed to encourage collected extract to settle at the bottom of the collection vessel 16. As was discussed above, after the sCO₂ is provided in the extraction section, it moves out of the extraction vessel through a conduit and enters the collection vessel 16 of the collection section. Fitted within the collection vessel is an outlet flow controller nut 100 which is designed to improve the extraction efficiency by improving the collection of the compounds which are extracted from the organic matter. An exemplary arrangement is shown in FIGS. 3 and 4.

The outlet flow controller nut 100 includes a tube which has an intake port 110 that faces upwards away from the bottom of the collection vessel in which it is installed. This upward facing orientation is with respect to gravity or any other force that would cause the fluids such as liquids or gases to settle downwards on account of their density. The upward facing intake port 110 is designed to cause fluids to flow up and over the outlet flow controller nut 100 before the fluids are collected by flowing through the intake port 110.

Without wishing to be bound by theory, it is believed that the upward facing intake port 110 on the outlet flow controller nut 100 causes the mixture of sCO₂ and dissolved compounds to more completely mix and swirl within the collection vessel. This increases the opportunities for desired compounds to “drop out” of the fluid mixture of sCO₂ and dissolved compounds, thereby increasing the efficiency of extraction for a given mass of fluid which enters the collection vessel. The outlet flow controller nut 100 results in improved extraction efficiency and represents and unexpected improvement over prior art collection vessels.

As described above, the outlet flow controller nut 100 has a tubular body. The tubular body may have a cross sectional profile that can be a circle, an ellipse, a square, a rectangle, a polygon, an irregular shape having no linear edges, and combinations thereof. The tubular body may be cast, stamped, extruded, machined, spun cast, sintered, or any combination of those methods. The tubular body may also be curved so that it faces any desired direction within the collection vessel. For example, the tubular body may be shaped as a “pigtail” which curls in a spiral, it may be curved to conform to the profile of the wall of the collection vessel.

The outlet flow controller nut 100 has an intake port 110, mentioned above, which has a cross sectional profile that is selected from a circle, an ellipse, a square, a rectangle, a polygon, an irregular shape having no linear edges, and combinations thereof. The intake port 110 may formed by casting, stamping, laser cutting, blade cutting, sintering, or any combination of these methods. There may be a single intake port, or there may be multiple intake ports (not shown).

The outlet flow controller nut 100 may be formed of any material, but in particular any material which is useful in the art of extracting or processing highly pure compounds for food and drugs. The materials should be durable and highly resistant to corrosion in the desired operating environment. Suitable materials include aluminum alloys, carbon steel, stainless steel, titanium alloys, nickel alloys, ceramics, and engineering polymers. Of the grades of stainless steel, the 200, 300, and 400 series are useful, and especially grades 304, 304L, 316, 316L, and 430. Of the grades of titanium, grade 5 of Ti-6A1-4V is most commonly used. Of the nickel alloys, those known by the tradenames HASTELLOY C-276 (generically UNS N10276 as a austenitic nickel-molybdenum-chromium alloy with tungsten addition) and HASTELLOY C-22 (generically UNS N06022 as a nickel-molybdenum-chromium alloy).

The outlet flow controller nut 100, besides having the above mentioned tubular body, also includes a first end 102 that includes a connection for a first fluid collection port 161 that is located in the collection vessel 16. The connection may be by any means that is formed within the outlet flow controller nut or on the outlet flow controller nut. The connection may be at least one of threads, brazing, welding, compression fitting, rivet structures, adhesives, tape, gaskets, and combinations of the above. As an example of a combination of the above, the outlet flow controller nut 100 may be formed with threads to match threads on the first fluid collection port 161 in the collection vessel, but which further includes a sealing tape that is formed of a non-reactive engineering polymer such as polytetrafluoroethylene or other fluoropolymers

Seals which can be used to mate the outlet flow controller nut to the first fluid collection port in the collection vessel include fluoroelastomers, perfluoroelastomers, tetrafluoro ethylene/propylene rubbers, polytetrafluoroethylene, fluorosilicones, silicone rubbers, and combinations of the above. These are selected for their excellent chemical resistance and performance in food and pharmaceutical applications.

Collection Vessel

Another aspect of the invention is the collection vessel 16 which houses the outlet flow controller nut 100 and which is responsible for collecting desirable compounds which are contained within the fluid stream of sCO₂ which enters the collection vessel. The invention may include one collection vessel, or it may include more than one collection vessel. The individual collection vessels may each be controlled independently to collect different compounds, or to extract the same compound in differing degrees of purity, grade, or chemical profile. In some embodiments, the number of collection vessels in an extraction apparatus is three (3), with the first collection vessel extracting the highest purity compounds, the second collection vessel extracting medium purity compounds, and the third collection vessel extracting the remaining available compound. In other embodiments, the combination of collection vessels is configured to extract a compound profile which results in a different mixtures of compounds collected from each collection vessel.

As discussed above, the collection vessel includes at least a first fluid collection port 161. The first fluid collection port 161 may be located in a top portion of the collection vessel, and therefore is configured to collect lighter fluid that has not yet “dropped out” of the sCO₂ based on the temperature and pressure of sCO₂. Lighter fluids are those which have lower molecular weights or which have lower densities. The first fluid collection port 161 may be connected to the outlet flow controller nut 100. There may be more than one first fluid collection port 110, but in general, the first fluid collection ports are configured to collect lighter, less dense fluids that have not dropped out of the sCO₂ within the collection vessel.

The collection vessel may also include at least one second collection port that is configured to extract heavier fluids. Heavier fluids are those which have higher molecular weights or which have higher densities. In particular, the second collection port may be positioned in a bottom portion of the collection vessel so that fluids which drop out of the sCO₂ can be efficiently collected. There may be one second collection port, or there may be multiple second fluid collection ports depending on the geometry of the collection vessel.

The collection vessel may also include at least one inlet port through which incoming fluids enter the collection vessel. The inlet port may include features which are designed to increase the mixing and swirling of the incoming fluid, such as a tube that directs the fluid into a spiral or swirling motion, or a tube which is configured into a spiral or pigtail shape. In some embodiments, there is one inlet port. In other embodiments, there is more than one inlet port included in the collection vessel depending on the geometry of the collection vessel.

The collection vessel may further include heaters, refrigeration, temperature sensors, pressure sensors, cameras, viewing ports, and other devices which are designed to aid in the sensing of conditions inside and control of the conditions within the collection vessel. The collection vessel may further include an access port which is designed for access by a human operator. In some embodiments, the collection vessel may include an additive injection port for the injection of additives to improve processing, such as gases, water, organic solvents, and other compounds. The collection vessel may also include a depressurization port which is designed to release pressure when necessary. The depressurization port can be manually controlled by the user, automatically controlled by software through an electromechanical actuator, or automatically activated by the valve itself, responsive to the pressure and/or temperature inside the collection vessel. The depressurization port may include one or more valves which are designed control or limit the pressure in the collection vessel, such as a pressure relief valve, pilot operated safety relief valve, or the like.

The collection vessel may be formed of similar materials described above with respect to the outlet flow controller nut. These materials may include any material which is useful in the art of extracting or processing highly pure compounds for food and drugs. The materials should be durable and highly resistant to corrosion in the desired operating environment. Suitable materials include aluminum alloys, carbon steel, stainless steel, titanium alloys, nickel alloys, ceramics, and engineering polymers. Of the grades of stainless steel, the 200, 300, and 400 series are useful, and especially grades 304, 304L, 316, 316L, and 430. Of the grades of titanium, grade 5 of Ti-6A1-4V is most commonly used. Of the nickel alloys, those known by the tradenames HASTELLOY C-276 (generically UNS N10276 as a austenitic nickel-molybdenum-chromium alloy with tungsten addition) and HASTELLOY C-22 (generically UNS N06022 as a nickel-molybdenum-chromium alloy).

The collection vessel, sometimes also referred to as a separation vessel, may include seals which are formed of similar materials described above with respect to the outlet flow controller nut. Seals which can be used in the collection vessel include fluoroelastomers, perfluoroelastomers, tetrafluoro ethylene/propylene rubbers, polytetrafluoroethylene, fluorosilicones, silicone rubbers, and combinations of the above. These are selected for their excellent chemical resistance and performance in food and pharmaceutical applications.

Software

Another aspect of the invention is that the overall extraction apparatus is controlled by software. The software is designed to automate the functioning of the overall extraction apparatus by controlling the different parts of the extraction apparatus in concert. In one embodiment, the invention describes a method for operating an extraction apparatus with the aid of a digital computer. In another embodiment, the extraction apparatus includes a digital computer which includes a processor and a non-transitory computer readable medium.

In one embodiment, there is a method for operating an extraction apparatus with the aid of a digital computer. The phrase “with the aid” means that the digital computer is used to improve and automate the functioning of the extraction apparatus. In particular, the fast processing speeds afforded by digital computers enable the extraction apparatus to perform precise adjustments to the temperature, pressure and flow rates of the sCO₂ and desirable compounds during extraction operations with greater effect than human operators can achieve. Additionally, the software has the advantage of making the entire extraction apparatus easier for a human operator to set and control.

The method includes the step of providing the digital computer with instructions based on the thermodynamic properties of CO₂. These instructions are based on a phase diagram of CO₂, which includes data for the locations of the solid phase, liquid phase, gas phase, and supercritical fluid phase, and also including the locations of the phase boundaries, triple point, and critical point. The phase diagram of CO₂ is well known to those of skill in the art. The instructions may be stored within a database and/or within a non-transitory computer readable medium within the digital computer.

Importantly, these instructions include the solubility of various compounds of interest within sCO₂. Compounds include those from the plants and trees Cassia, Cinnamon, Sassafras, Wood, Camphor, Cedar, Rosewood, Sandalwood, Agarwood, Rhizome, Galangal, Ginger, Basil, Bay Leaf, Buchu, Cannabis, Cinnamon, Sage, Eucalyptus, Guava, Lemon grass, Midaleuca, Oregano, Patchouli, Peppermint, Pine, Rosemary, Spearmint, Tea tree, Thyme, Tsuga, Wintergreen, Resin, Benzoin, Copaiba, Frankincense, Myrrh, Chamomile, Clary sage, Clove, Scented geranium, Hops, Hyssop, Jasmine, Lavender, Manuka, Marjoram, Orange, Rose, Ylang-ylang, Peel, Bergamot, Grapefruit, Lemon, Lime, Orange, Mango, Tangerine, Root and Valerian, Berries including Allspice and Juniper; Seeds including Anise, Buchu, Celery, Cumin, Nutmeg oil; truffles; or the like. As mentioned above, sCO₂ is useful because it has different solubility coefficients with different compounds depending on its pressure and temperature. That, combined with its inert properties, makes sCO₂ an excellent solvent choice for extraction applications. The present invention is unique in combining these properties of sCO₂ with the fast and precise control afforded by a digital computer. The solubility of the compounds and corresponding temperatures and pressures of sCO₂ are stored within a database and/or within a non-transitory computer readable medium which may be a part of the digital computer.

In some embodiments, the charge for extraction is a plant charge, such as, but not limited to any variety within Cannabis genus, including, but not limited to, Cannabis sativa, Cannabis indica, and Cannabis ruderalis (collectively referred to as “Cannabis” throughout the disclosure), including varieties that are cultivated for medical, industrial, textile, fuel, paper, chemical, food, and recreational purposes, among other uses. The plant charge material may be any part of the plant, including the stems, leaves, seeds, flowers, buds, roots, or combinations of the above. In some embodiments, the plant charge of Cannabis is used for the extraction of various useful compounds, including cannabinoids, tetrahydrocannabinol (THC), cannabinoid isomers, cannabinoid stereoisomers, tetrahydrocannabinolic acid (THCA), cannabidiol (CBD), cannabidiolic acid (CBDA), cannabinol, (CBN), cannabigerol (CBG), cannabichromene (CPC), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannebielsoin (CBE), cannabicitran (CBT), and combinations and derivatives of the above.

The instructions and/or the database may be stored on a non-transitory computer readable medium, examples of which are well known in the art. The term non-transitory computer readable medium means any medium that a digital computer can utilize to store instructions, where the instructions are not merely stored as a transitory signal. Examples of non-transitory computer-readable medium include but are not limited to printed matter on paper or other substrates, magnetic hard disk drives, solid state storage devices, NAND drives, NOR drives, EPROMs, EEPROMs, magnetic floppy disk drives, optical media, holographic media, compact discs (CDs), digital versatile disk (DVDs), Blu-Ray discs (BD), magnetic tape drives, Random Access Memory (RAM) based on DRAM, non-volatile phase change memory, magneto optical discs, 3D XPoint memory, and the like.

The instructions are based on the thermodynamic properties of CO₂ and are derived from the fundamental equation for the specific Helmholtz free energy. As is known in the art, the Helmoltz free energy is expressed in dimensionless form by Equation (1):

$$\frac{f ( ρ , T )}{RT} = ϕ ( δ , τ ) = {ϕ}^{o} ( δ , τ ) + {ϕ}^{r} ( δ , τ )$$

In that equation, ϕ represents the dimensionless Helmholtz free energy, ϕ^{o} represents the ideal gas part, and ϕ^{r} represents the residual part of the dimensionless Helmholtz free energy. The ideal-gas part is shown by Equation (2) below:

$${ϕ}^{o} = ln δ + {n}_{1}^{o} + {n}_{2}^{o} τ + {n}_{3}^{o} ln τ + {\sum }_{i = 4}^{8} {n}_{i}^{o} ln [ 1 - {e}^{- {γ}_{i}^{o} τ} ]$$

where δ=ρ/ρ_{c} and τ=T_{c}/T

The residual part is described by Equation (3) below:

$${ϕ}^{r} = {\sum }_{i = 1}^{7} {n}_{i} {δ}^{{d}_{i}} {τ}^{{t}_{i}} + {\sum }_{i = 8}^{51} {n}_{i} {δ}^{{d}_{i}} {τ}^{{t}_{i}} {e}^{- {δ}^{{c}_{i}}} + {\sum }_{i = 52}^{54} {n}_{i} {δ}^{{d}_{i}} {τ}^{{t}_{i}} {e}^{- {{α}_{i} ( δ - {ɛ}_{i} )}^{2} - {{β}_{i} ( τ - {γ}_{i} )}^{2}} + {\sum }_{i = 55}^{56} {n}_{i} {Δ}^{{b}_{i}} δ ψ$$

$$Δ = {θ}^{2} + {{B}_{i} [ {( δ - 1 )}^{2} ]}^{{α}_{i}}$$

$$θ = ( 1 - τ ) + {{A}_{i} [ {( δ - 1 )}^{2} ]}^{\frac{1}{2 {β}_{i}}}$$

$$ψ = {e}^{- {{C}_{i} ( δ - 1 )}^{2} - {{D}_{i} ( t - 1 )}^{2}}$$

where δ=ρ/ρ_{c} and τ=T_{c}/T

More fully, the residual part ϕ^{r} is described by the equations and derivatives below:

$${ϕ}^{r} = {\sum }_{i = 1}^{7} {n}_{i} {δ}^{{d}_{i}} \text{?} + {\sum }_{i = 8}^{51} {n}_{i} {δ}^{{d}_{i}} {τ}^{{b}_{i}} {e}^{- {δ}^{{c}_{i}}} + {\sum }_{i = 52}^{54} {n}_{i} {δ}^{{d}_{i}} \text{?} \text{?} + {\sum }_{i = 55}^{56} {n}_{i} {Δ}^{{b}_{i}} δ ψ$$

$$with Δ = {θ}^{2} + {{B}_{i} [ {( δ - 1 )}^{2} ]}^{{α}_{i}}$$

$$θ = ( 1 - r ) + {{A}_{i} [ {( δ - 1 )}^{2} ]}^{\frac{1}{2 {β}_{i}}}$$

$$ψ = {e}^{- {{C}_{i} ( δ - 1 )}^{2} - {{D}_{i} ( τ - 1 )}^{2}} \\ \text{?} = {\sum }_{i = 1}^{7} {n}_{i} {d}_{i} {δ}^{{d}_{i} - 1} \text{?} + {\sum }_{i = 8}^{51} {n}_{i} {e}^{- {δ}^{{c}_{i}}} [ {δ}^{{d}_{i} - 1} \text{?} ( {d}_{i} - {c}_{i} {δ}^{{c}_{i}} ) ] + {\sum }_{i = 52}^{54} {n}_{i} {δ}^{{d}_{i}} {t}^{{t}_{i}} \text{?} [ \frac{{d}_{i}}{δ} - 2 {α}_{i} ( δ - {ɛ}_{i} ) ] + {\sum }_{i = 55}^{56} {n}_{i} [ {Δ}^{{b}_{i}} ( ψ + δ \frac{\partial ψ}{\partial δ} ) + \frac{\partial {Δ}^{{b}_{i}}}{\partial δ} δ ψ ] \\ \text{?} = {\sum }_{i = 1}^{7} {n}_{i} {d}_{i} ( {d}_{i} - 1 ) {δ}^{{d}_{i} - 2} {τ}^{{t}_{i}} + {\sum }_{i = 8}^{51} {n}_{i} \text{?} [ {δ}^{{d}_{i} - 2} {τ}^{{t}_{i}} ( ( {d}_{i} - {c}_{i} {δ}^{{c}_{i}} ) ( {d}_{i} - 1 - {c}_{i} {δ}^{{c}_{i}} ) - {c}_{i}^{2} {δ}^{{c}_{i}} ) ] + {\sum }_{i = 52}^{54} {n}_{i} {τ}^{{t}_{i}} \text{?} \cdot [ - 2 {α}_{i} {δ}^{{d}_{i}} + 4 {α}_{i}^{2} {{δ}^{{d}_{i}} ( δ - {ɛ}_{i} )}^{2} - 4 {d}_{i} {α}_{i} {δ}^{{d}_{i} - 1} ( δ - {ɛ}_{i} ) + {d}_{i} ( {d}_{i} - 1 ) {δ}^{{d}_{i} - 2} ] + {\sum }_{i = 55}^{56} {n}_{i} [ {Δ}^{{b}_{i}} ( 2 \frac{\partial ψ}{\partial δ} + δ \frac{{\partial }^{2} ψ}{\partial {δ}^{2}} ) + 2 \frac{\partial {Δ}^{{b}_{i}}}{\partial δ} ( ψ + δ \frac{\partial ψ}{\partial δ} ) + \frac{{\partial }^{2} {Δ}^{{b}_{i}}}{\partial {δ}^{2}} δψ \\ \text{?} = {\sum }_{i = 1}^{7} {n}_{i} {t}_{i} \text{?} + {\sum }_{i = 8}^{51} {n}_{i} {t}_{i} {δ}^{{d}_{i}} \text{?} + {\sum }_{i = 52}^{54} {n}_{i} {δ}^{{d}_{i}} \text{?} \text{?} [ \frac{{t}_{i}}{τ} - 2 {β}_{i} ( τ - {γ}_{i} ) ] + {\sum }_{i = 55}^{56} {n}_{i} δ [ \frac{\partial {Δ}^{{b}_{i}}}{\partial τ} ψ + {Δ}^{{b}_{i}} \frac{\partial ψ}{\partial τ} ] \\ \text{?} = {\sum }_{i = 1}^{7} {n}_{i} {t}_{i} ( {t}_{i} - 1 ) {δ}^{{d}_{i}} {τ}^{{t}_{i - 2}} + {\sum }_{i = 8}^{51} {n}_{i} {t}_{i} ( {t}_{i} - 1 ) {δ}^{{d}_{i} {τ}^{{t}_{i} - 2}} {e}^{- {δ}^{{c}_{i}}} + {\sum }_{i = 52}^{54} {n}_{i} {δ}^{{d}_{i}} {τ}^{{t}_{i}} \text{?} [ {( \frac{{t}_{i}}{τ} - 2 {β}_{i} ( τ - {γ}_{i} ) )}^{2} - \frac{{t}_{i}}{{τ}^{2}} - 2 {β}_{i} ] + {\sum }_{i = 55}^{56} {n}_{i} δ [ \frac{{\partial }^{2} {Δ}^{{b}_{i}}}{\partial {τ}^{2}} ψ + 2 \frac{\partial {Δ}^{{b}_{i}}}{\partial τ} \frac{\partial ψ}{\partial τ} + {Δ}^{{t}_{i}} \frac{{\partial }^{2} ψ}{\partial {τ}^{2}} ] \\ \text{?} = {\sum }_{i = 1}^{7} {n}_{i} {d}_{i} {t}_{i} {δ}^{{d}_{i} - 1} {τ}^{{t}_{i} - 1} + {\sum }_{i = 8}^{51} {n}_{i} {t}_{i} {δ}^{{d}_{i} - 1} {τ}^{{t}_{i} - 1} ( {d}_{i} - {c}_{i} {δ}^{{c}_{i}} ) {e}^{- {δ}^{{c}_{i}}} + {\sum }_{i = 52}^{54} {n}_{i} {δ}^{{d}_{i}} {τ}^{{t}_{i}} \text{?} [ \frac{{d}_{i}}{δ} - 2 {α}_{i} ( δ - {ɛ}_{i} ) ] [ \frac{{t}_{i}}{τ} - 2 {β}_{i} ( τ - {γ}_{i} ) ] + {\sum }_{i = 55}^{56} {n}_{i} [ {Δ}^{{b}_{i}} ( \frac{\partial ψ}{\partial τ} + \frac{{\partial }^{2} ψ}{\partial δ \partial τ} ) + δ \frac{\partial {Δ}^{{b}_{i}}}{\partial δ} \frac{\partial ψ}{\partial τ} + \frac{\partial {Δ}^{{b}_{i}}}{\partial τ} ( ψ + δ \frac{\partial ψ}{\partial δ} ) + \frac{{\partial }^{2} {Δ}^{{b}_{i}}}{\partial δ \partial τ} δψ ] \\ \text{?} \text{indicates text missing or illegible when filed}$$

Furthermore, derivatives of the distance function Δ^{bi} are shown below:

$$\frac{\partial {Δ}^{{b}_{i}}}{\partial δ} = {b}_{i} {Δ}^{{b}_{i} - 1} \frac{\partial Δ}{\partial δ}$$

$$\frac{{\partial }^{2} {Δ}^{{b}_{i}}}{\partial {δ}^{2}} = {b}_{i} \{ {Δ}^{{b}_{i} - 1} \frac{{\partial }^{2} Δ}{\partial {δ}^{2}} + ( {b}_{i} - 1 ) {{Δ}^{{b}_{i} - 2} ( \frac{\partial Δ}{\partial δ} )}^{2} \}$$

$$\frac{\partial {Δ}^{{b}_{i}}}{\partial τ} = - 2 θ {b}_{i} {Δ}^{{b}_{i} - 1}$$

$$\frac{{\partial }^{2} {Δ}^{{b}_{i}}}{\partial {τ}^{2}} = 2 {b}_{i} {Δ}^{{b}_{i} - 1} + 4 {θ}^{2} {b}_{i} ( {b}_{i} - 1 ) {Δ}^{{b}_{i} - 2}$$

$$\frac{{\partial }^{2} {Δ}^{{b}_{i}}}{\partial δ \partial τ} = - {A}_{i} {b}_{i} \frac{2}{{β}_{i}} {{Δ}^{{b}_{i} - 1} ( δ - 1 ) [ {( δ - 1 )}^{2} ]}^{\frac{1}{2 {β}_{i}} - 1} - 2 θ {b}_{i} ( {b}_{i} - 1 ) {Δ}^{{b}_{i} - 2} \frac{\partial Δ}{\partial δ}$$

$$with$$

$$\frac{\partial Δ}{\partial δ} = ( δ - 1 ) \{ {A}_{i} θ {\frac{2}{{β}_{i}} [ {( δ - 1 )}^{2} ]}^{\frac{1}{2 {β}_{i}} - 1} + 2 {B}_{i} {{a}_{i} [ {( δ - 1 )}^{2} ]}^{{a}_{i} - 1} \}$$

$$\frac{{\partial }^{2} Δ}{\partial {δ}^{2}} = \frac{1}{( δ - 1 )} \frac{\partial Δ}{\partial δ} + {( δ - 1 )}^{2} \{ 4 {B}_{i} {{a}_{i} ( {a}_{i} - 1 ) [ {( δ - 1 )}^{2} ]}^{{α}_{i} - 2} + 2 {{A}_{i}^{2} ( \frac{1}{{β}_{i}} )}^{2} {\{ {[ {( δ - 1 )}^{2} ]}^{\frac{1}{2 {β}_{i}} - 1} \}}^{2} + {A}_{i} θ \frac{4}{{β}_{i}} {( \frac{1}{2 {β}_{i}} - 1 ) [ {( δ - 1 )}^{2} ]}^{\frac{1}{2 {β}_{i}} - 2} \}$$

Derivatives of the exponential function Ψ are given by the equations below:

$$\frac{\partial ψ}{\partial δ} = - 2 {C}_{i} ( δ - 1 ) ψ$$

$$\frac{{\partial }^{2} ψ}{\partial {δ}^{2}} = \{ 2 {{C}_{i} ( δ - 1 )}^{2} - 1 \} 2 {C}_{i} ψ$$

$$\frac{\partial ψ}{\partial τ} = - 2 {D}_{i} ( τ - 1 ) ψ$$

$$\frac{{\partial }^{2} ψ}{\partial {τ}^{2}} = \{ 2 {{D}_{i} ( τ - 1 )}^{2} - 1 \} 2 {D}_{i} ψ$$

$$\frac{{\partial }^{2} ψ}{\partial δ \partial τ} = 4 {C}_{i} {D}_{i} ( δ - 1 ) ( τ - 1 ) ψ$$

Values within these equations are given by the nomenclature list below:

Thermodynamic quantities:

| | |
|---|---|
| B | Second viral coefficient |
| cₚ | Specific isobaric heat capacity |
| cᵥ | Specific isochoric heat capacity |
| f | Specific Helmholtz free energy |
| h | Specific enthalpy |
| M | Molar mass |
| p | Pressure |
| R | Specific gas constant |
| Rₘ | Molar gas constant |
| s | Specific entropy |
| T | Absolute temperature |
| u | Specific internal energy |
| w | Speed of sound |
| βₛ | Isentropic throttling coefficient |
| δ | Reduced density, δ = ρ/ρ_{c} |
| δ_{T} | Isothermal throttling coefficient |
| ϕ | Dimensionless Helmholtz free energy, ϕ = f/(RT) |
| κ_{T} | Isothermal compressibility |
| μ | Joule-Thomson coefficent |
| ρ | Mass density |
| τ | Inverse reduced temperature, τ = T_{ϵ}/T |

Superscripts

| | |
|---|---|
| o | Ideal-gas property |
| r | Residual |
| ′ | Staurated liquid state |
| ″ | Saturated vapor state |

Subscripts

| | |
|---|---|
| c | critical point |
| [symbol] | saturation |
| t | triple point |

[symbol]

indicates data missing or illegible when filed

The above coefficient data includes values for the thermodynamic quantities and their subscripts and superscript variations which correspond to CO₂. In other words, in a first embodiment, the thermodynamic quantities which are listed are those which correspond to CO₂. However, the invention is not necessarily so limited. The applicants also contemplate that other compounds, such as water, may be used with corresponding coefficients, alone or in combination with CO₂. Thus, in further embodiments, the coefficients correspond to the thermodynamic quantities associated with water, and in even further embodiments, the coefficients correspond to thermodynamic quantities associated with a mixture of water and CO₂.

The digital computer also includes at least a processor, and in some embodiments a memory which is used to execute the instructions and information that is included on the non-transitory computer readable medium and/or the database. The processor may be a general purpose processor of a RISC or CISC architecture which may include but is not limited to an ARM processor, x86 processor, x86-64 processor, MIPS processor, and POWER processor. Alternatively, the processor may include instructions within the chip, as in an ASIC processor or a FPGA processor. The memory may be on the processor or off-die, and can be SRAM or DRAM.

With these equations stored and the corresponding coefficients, the digital computer causes the extraction apparatus to provide CO₂ in a supercritical state in order to extract desirable compounds from a “charge,” or sample or quantity of plant material which placed within an extraction vessel. To accomplish this, the digital computer relies on the instructions and database, and the processor controls the operation of the various parts of the extraction apparatus.

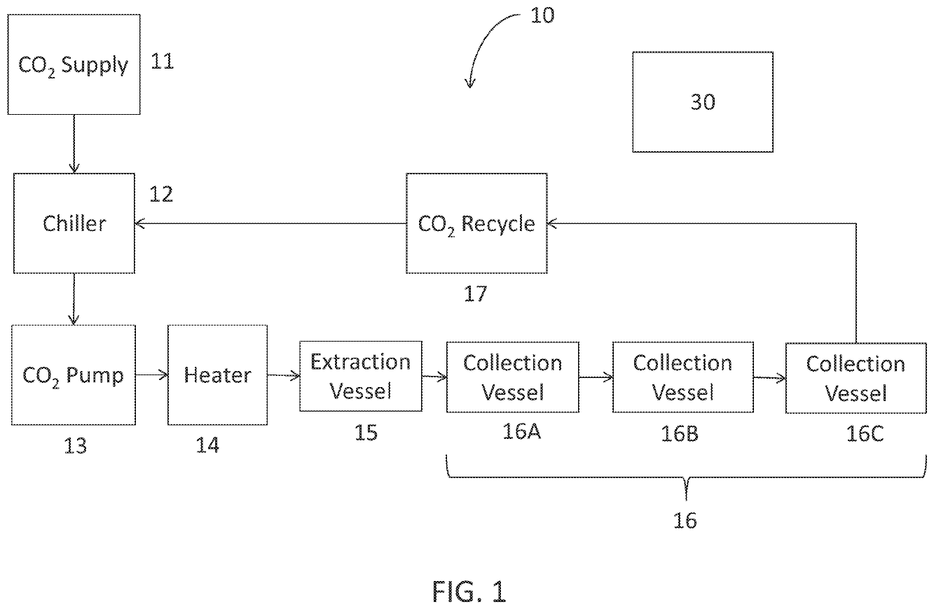

Turning to FIG. 1, a flowchart of the extraction apparatus and its attendant process steps for extraction 10 is described. Each of these steps is monitored and adjusted by the digital computer at frequent intervals. In Step 11, a supply of CO₂ and any other additives is provided, typically from a pressurized tank or sublimating from an enclosed block. The pressure within the tanks is typically about 500 psia to about 900 psia. The digital computer may monitor and adjust parameters of operation based on temperatures and pressures measured in the CO₂ supply using sensors and relays.

In Step 12, the supply of CO₂ is piped to a chiller, which removes excess heat and brings the CO₂ to a temperature that is sufficiently cool such that when subsequently pumped, any heat of compression causes it to rise to the supercritical portion of the phase. For CO₂, this means a temperature of about −5° C. to about 5° C. Next, in Step 13, a pump compresses the CO₂ so that it passes the critical point and becomes supercritical. The CO₂ may be pressurized up to about 7,500 psia to about 20,000 psia. In some embodiments, the pressure of the CO₂ may be about 400 psia, about 1,000 psia, about 1,500 psia, about 2,000 psia, about 2,500 psia, about 3,000 psia, about 4,000 psia, about 4,500 psia, about 5,000 psia, about 5,500 psia, about 6,000 psia, about 6,500 psia, about 7,000 psia, about 7,500 psia, about 8,000 psia, about 8,500 psia, about 9,000 psia, about 9,500 psia, about 10,000 psia, about 10,500 psia, about 11,000 psia, about 11,500 psia, about 12,000 psia, about 12,500 psia, about 13,000 psia, about 13,500 psia, about 14,000 psia, about 14,500 psia, about 15,000 psia, about 15,500 psia, about 16,000 psia, about 16,500 psia, about 17,000 psia, about 17,500 psia, about 18,000 psia, about 18,500 psia, about 19,000 psia, about 19,500 psia, about 20,000 psia, or any range of any two of the above listed pressure values. In Step 13, the CO₂ may be heated to about 1° C. to about 250° C. and maintained at a pressure set between about 400 psi to about 20,000 psi. The temperature of the CO₂ may be about 50° C., about 100° C., about 150° C., about 200° C., about 250° C., about 300° C., about 350° C., about 400° C., or any range of any two of the above listed temperature values.

Following Step 14, the CO₂, which is in a supercritical state and denoted sCO₂, flows to at least one extraction vessel. The extraction vessel, denoted by Step 15 is loaded with a charge of organic material which contains the desired compounds for extraction. The digital computer can adjust the temperature within the extraction vessel using band heaters or any other similar device. In the extraction vessel, the sCO₂ flows over the desired compounds for extraction which causes the desired compounds to be take up into the sCO₂ and carried out into the extraction vessel. Critically, the digital computer controls the exact temperature and pressure, and therefore the affinity of the sCO₂ to compounds of interest within the extraction vessel.

In Step 16, the sCO₂, which is laden with compounds of interest which were taken up during the extraction of the charge material in Step 15, proceeds to at least one collection vessel. If there is more than one collection vessel, they can be denoted as Steps 16A, 16B, 16C, and so forth. Additional collection vessels may be added and are not shown in the drawings. In each collection vessel, the same or a different compounds of interest “falls out” of the sCO₂ as the pressure and/or temperature is adjusted to cause the extracted materials to be collected. The digital computer ensures that each collection vessel is controlled during step 16. Each collection vessel include electric resistance heaters, which are wrapped around the collection vessel and interface with the digital computer. In the alternative, there may be electric resistance heaters contained within the chamber of each collection vessel, or may be embedded within the walls of each collection vessel. The electric resistance heaters may be controlled by the computer to precisely control the temperature in each collection vessel, thereby enabling the human operator to select exact compounds for collection in each of the collection vessels.

After at least one collection step involving at least one collection vessel, the CO₂ is recycled in Step 17. In this step, the computer measures the temperature and pressure of the CO₂ to ensure that it is in the form of a gas and that most compounds have been collected in each of the collection vessels. Similar to the other steps and sections mentioned above, the computer controls the CO₂ through the use of electric resistance heaters which are contained within the chamber of each collection vessel. Following the recycling of Step 16, the now clean CO₂ returns to the chiller of Step 11 where it begins the cycle again.

The software also enables the digital computer to control other parts of the extraction process. In between the CO₂ supply of step 11 and the chiller of step 12, valves and heaters may be used alone or together to control the exact flow and temperature of the CO₂ as it moves through piping. In between the chiller of step 12 and the CO₂ pump of step 13, valves and heaters may be used alone or together to control the exact flow and temperature of the CO₂ as it moves through piping. At this stage, a flow meter may also be employed to measure the amount of CO₂ that is being fed to the pump. In between the CO₂ pump of step 13 and the heater of step 14, valves and heaters may be used alone or together to control the exact flow and temperature of the CO₂ as it moves through piping. In between the heater of step 14 and the extraction vessel of step 15, valves and heaters may be used alone or together to control the exact flow and temperature of the CO₂ as it moves through piping. In between the extraction vessel of step 15 and the at least one collection vessel of steps 16, 16A, 16B, 16C, and so forth, valves and heaters may be used alone or together to control the exact flow and temperature of the CO₂ as it moves through piping. Valves and heaters may be used alone or together to control the temperature and pressure of the CO₂ between each of the different collection vessels. In between the collection vessel of steps 16, 16A, 16B, 16C, and so forth, valves and heaters may be used alone or together to control the temperature and pressure of the CO₂ as it is treated and recycled for the process to start again. Again, each valve and heater is controlled by the digital computer, which enables precise control of each step and sub-step of the extraction process.

Valves, heaters, and pressure sensors may be provided during or between each step. These enable the digital computer to both control and monitor the process. Each valve, heater, and pressure sensor may optionally include its own digital computer circuitry that permits it to have a degree of autonomy with respect to the digital computer that controls all of the other components.

The software and associated extraction apparatus may be controlled locally, i.e., by a human operator that sets the values on the extraction apparatus itself through a user interface. In such embodiments, the software and associated extraction apparatus utilizes computer terminal which may include one or more of a computer screen, a computer touchscreen, a keyboard, a mouse, a microphone, a speaker. The software may respond to the user viewing the computer screen and entering commands on another interface, such as the keyboard, mouse, and microphone. The computer touchscreen may be used to enter commands by the user touching the screen and registering inputs, alone or in combination with the other input methods.

Alternatively or in combination with the above local control, the software and associated extraction apparatus may be controlled remotely. Remote control or monitoring of the software may be accomplished through any networking protocol known in the art, such as TCP/IP, SSH, HTTPS, and combinations of those protocols. In one embodiment, the software presents a user interface in the form of a web page, which is accessed via an encrypted HTTPS connection. Such an interface may be controlled remotely or locally from a web browser. Alternatively, the software may itself encompass remote access software, such as software for mobile devices or mobile computer terminals.

The software may further include scheduling timers which enable the user to schedule a time to start production, even if a user is not present. When used alone or in combination with remote control software, the inclusion of scheduling timers enables further flexibility in operating the extraction apparatus, even when access to the Internet or local area networks is limited.

In some embodiments, the software may save or log extraction profiles, previously selected extraction runs, previously customized or inputted extraction runs, errors, calibration information, and other such information. This information may be specific compounds of interest which are found within organic matter of interest for extraction. A human operator can therefore precisely input and review the information that is related to the operation of the extraction apparatus. The information may also be part of a database that is included with the software and is specific to each compound of interest and each kind of organic matters that is to be extracted by the extraction apparatus.

In some embodiments, the software is capable of informing the human operator about conflicts in the selected parameters which are entered or stored in the digital computer, the database, the extraction profiles, and so forth. This feature is a major advantage over prior art extraction apparatus, which relied on time consuming and costly trial and error by the human operator to determine which settings are “best” for a given organic matter and compound of interest, only to have to switch to another organic matter and/or compound of interest in another production run. The difficulty lies not only in the different production runs which are performed, but also in the fact that three co-dependent variables must be adjusted for proper operation. First, the temperature must be controlled, for instance using heaters and/or the pump which is included within the extraction apparatus. Second, the pressure must be controlled, for instance using heaters and/or the pump which included within the extraction apparatus. Third and most crucially, the density of the sCO₂ must be controlled, because the density of sCO₂ is the variable that is connected with its ability to act as a solvent for extracting various compounds of interest within the extraction apparatus. However, because the density of sCO₂ is altered by its position within the CO₂ phase diagram as represented by temperature and pressure, controlling the density and therefore extraction solvency of the sCO₂ requires control of the temperature and pressure. By controlling the temperature, pressure, and density of the sCO₂ in a fully automated fashion, the software of the present invention is able for the first time to quickly and effectively control the extraction of compounds of interest from organic matter, with minimal downtime between production runs.

Extraction Apparatus

The overall extraction apparatus is designed to extract compounds of interest from selected organic matter using sCO₂. As discussed above, the extraction apparatus includes components which are intended to increase the extraction efficiency, such as the outlet flow controller nut and the software which is loaded onto the digital computer. The extraction apparatus includes components which mirror the steps described above in relation to the software and digital computer. As described above, each step may be controlled by the digital computer 30 and the software (not shown).

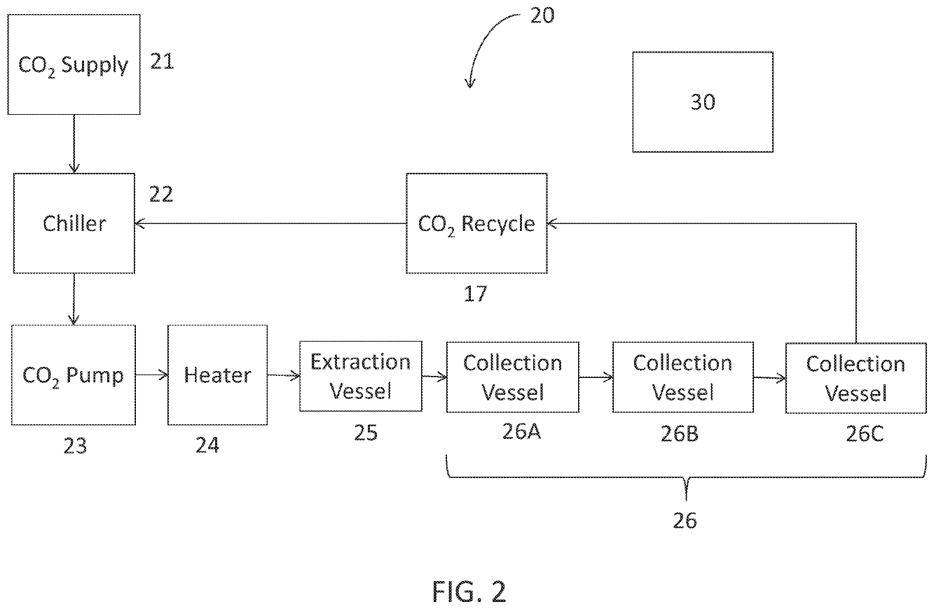

Referring now to FIG. 2, a flowchart of the extraction apparatus 20 and each of the different components is described. As above, each part of the extraction apparatus is monitored and adjusted by the digital computer 30 at frequent intervals. In CO₂ supply 21, CO₂ is provided from a supply feed which can be tank of compressed CO₂ gas. Alternatively, CO₂ supply 21 may be provided by sublimating solid CO₂, desorbing CO₂ from an adsorptive material, chemical reaction, or any other manner known in the art.

Next, chiller 22 cools the CO₂ supply and any recycled CO₂ gas from the process to a temperature that is suitable for intake into the CO₂ pump 23. The chiller can function by refrigeration, by direct heat exchange with the ambient atmosphere, by liquid cooling, or any other manner known in the art. The chiller may be controlled by the digital computer 30 so that the precise temperature of the CO₂ can be selected and controlled.

Following treatment by the chiller, the CO₂ enters the CO₂ pump 23, where it is compressed and heated by mechanical action to the temperature required to operate the extraction apparatus. At this stage (after the chiller but before the pump), a flow meter may also be employed to measure the amount of CO₂ that is being fed to the pump. The CO₂ pump 23 may be a positive displacement pump such as a piston pump, rotary lobe pump, rotary gear pump, or the like. The CO₂ pump 23 may be controlled by the digital computer 30 so that the precise pressure of the CO₂ can be selected and controlled.

After the CO₂ exits the CO₂ pump 23, it is at or close to a supercritical state. At this point, the CO₂ moves to a heater 24 where it is heated to as to ensure that the CO₂ is at a supercritical state. The heater may be in the form of a heat pump, an electrical resistance heater, a natural gas burner, a propane burner, or any other hydrocarbon fuel burner. The heater may be controlled by the digital computer 30 so that it maintains the CO₂ within a supercritical state, and so that the density of the sCO₂ is controlled to match the extraction profile that is set within the software.

Next, the sCO₂ enters the extraction vessel 25, which contains a charge material which has been loaded inside the extraction vessel 25 and which contains compounds of interest. As described above, the sCO₂ has its temperature and pressure precisely controlled using the digital computer 30 so that it selects only certain compounds for extraction.

After the extraction vessel, the sCO₂ is laden with extracted compounds of interest, which proceeds to one or more collection vessels 26. When multiple collection vessels are present, they can be designated as collection vessels 26A, 26B, 26C, and so forth. The collection vessels may each be used to extract different compounds of interest, or they may be used to extract increasing or decreasing levels of purity of the same compounds of interest. Within each extraction vessel, the temperature and pressure is controlled by heaters or expansion valves which causes the compounds of interest to “fall out” or condense out of the supercritical CO₂. As the sCO₂ lowers its temperature and/or pressure, it becomes closer and closer, until it finally becomes, a gas. These operations are controlled as in other parts of the extraction apparatus 20 by the digital computer 30. There can be one, two, three, or more collection vessels. There can be heaters (not shown) placed within or between the collection vessels to precisely control the temperature and pressure of each.

After the sCO₂ proceeds through the one or more collection vessels of steps 16, 16A, 16B, 16C, and so forth, it is in the state of a heated gas. Because CO₂ is inert at most typical temperatures and pressures, it is largely pure and free of the compounds of interest, which were collected within the collection vessels 16, 16A, 16B, 16C, and so forth. However, there may still be traces of residual compounds which may need to be removed from the CO₂, both in the interest of maintaining the integrity of upstream parts such as the chiller 22 and CO₂ pump 23, and also in the interest of maintaining the quality and purity of the extracted compounds. For this, a CO₂ recycle stage 27 is included to extract any remaining compounds from the CO₂ before it is returned to the chiller 22 at the beginning of the extraction apparatus 20.

The recycle stage 27 may include both chemical and mechanical means for purifying the CO₂ gas. Chemical means include chemical reaction, absorption, or adsorption. In some embodiments, chemical absorption or adsorption may be by a sorbent such as activated carbon, zeolite, diatomaceous earth, clay, silica gel, and the like, and combinations of the above. In some embodiments, mechanical means may include fractional distillation, refrigeration, heating, vortex separation, vortex condensation, and the like, and combinations of the above. Following the recycle stage 27, the purified CO₂ gas is returned to the chiller so that it can restart its circulation through the extraction apparatus 20.

Valves, heaters, and pressure sensors may be provided during or between each part of the overall extraction apparatus. These enable the digital computer to both control and monitor the process. Each valve, heater, and pressure sensor may optionally include its own digital computer circuitry that permits it to have a degree of autonomy with respect to the digital computer that controls all of the other components.

1. An outlet flow controller nut, comprising:
a tubular body, comprising
a first end of the tubular body that includes a connection for a first fluid collection port located in the upper portion of a collection vessel,
a second end of the tubular body that includes an intake port on the top side of the tubular body,
wherein the intake port on the top side of the tubular body causes fluids to flow up and over the outlet flow controller nut before the fluids are collected by flowing through the intake port.

2. The outlet flow controller nut of claim 1, wherein the connection is selected from the group consisting of threads, brazing, welding, compression fitting, rivet structures, adhesive, tape, gaskets, and combinations thereof.

3. The outlet flow controller nut of claim 1, wherein the tubular body has a cross-sectional profile selected from the group consisting of a circle, an ellipse, a square, a rectangle, a polygon, an irregular shape having no linear edges, and combinations thereof.

4. The outlet flow controller nut of claim 1, wherein the intake port has a profile selected from the group consisting of a circle, an ellipse, a square, a rectangle, a polygon, an irregular shape having no linear edges, and combinations thereof.

5. A collection vessel comprising:
an outlet flow controller nut, comprising a tubular body, comprising
a first end of the tubular body that includes a connection for a first fluid collection port located in an upper portion of a collection vessel,
a second end of the tubular body that includes an intake port on the top side of the tubular body,
wherein the intake port on the top side of the tubular body causes fluids to flow up and over the outlet flow controller nut before the fluids are collected by flowing through the intake port; and
a second fluid collection port located in a lower portion of the collection vessel; and
an inlet port.

6. A method of operating an extraction apparatus with the aid of a digital computer, comprising:
providing the digital computer with instructions based on the thermodynamic properties of CO₂;
wherein the instructions based on the thermodynamic properties of CO₂ are derived from the fundamental equation for the specific Helmholtz free energy,
providing the digital computer with a database that includes the coefficient data usable in the fundamental equation for the specific Helmholtz free energy;
wherein the coefficient data is specific to the thermodynamic properties of CO₂;
wherein the digital computer causes the extraction apparatus to provide CO₂ in a supercritical state for extraction of compounds from a charge material,
wherein the extracted compounds selectively extracted based on the temperature and pressure of the supercritical CO₂, which is monitored and adjusted by the digital computer at frequent intervals using the instructions and the coefficient data.

7. An extraction apparatus for the extraction of compounds from a charge material, comprising:
a digital computer, which includes a processor and a non-transitory computer readable medium,
wherein the non-transitory computer readable medium includes instructions based on the thermodynamic properties of CO₂ which are derived from the fundamental equation for the specific Helmholtz free energy,
wherein the non-transitory computer readable medium includes a database that includes coefficient data usable in the fundamental equation for the specific Helmholtz free energy, and which is specific to the thermodynamic properties of CO₂; and
wherein during operation, the extraction apparatus provides CO₂ in a supercritical state for extraction of compounds from a charge material,
wherein during operation, the extraction apparatus selectively extracts desired compounds from the charge material based on the temperature and pressure of the supercritical CO₂, which is monitored and adjusted by the digital computer at frequent intervals using the instructions and the coefficient data.

8. The extraction apparatus of claim 7, further comprising a collection vessel, wherein an outlet flow controller nut is positioned within the collection vessel and is connected to a first fluid collection port.

9. The extraction apparatus of claim 7, further comprising a liquid displacement pump for the CO₂ which is controlled by the digital computer.

10. The extraction apparatus of claim 7, further comprising a temperature sensor and a pressure sensor, each of which transmit signals.

11. The extraction apparatus of claim 7, further comprising a heater that is controlled by the digital computer.

12. The extraction apparatus of claim 7, wherein the digital computer automatically calculates the density of the CO₂ which is based on the temperature and pressure of the CO₂ within each vessel of the extraction apparatus.

13. The extraction apparatus of claim 7, further comprising a phase monitor window which permits observation of the solubility of the charge material in the supercritical CO₂.

14. The extraction apparatus of claim 7, wherein the digital computer provides a user interface that permits a human operator to control the density of the supercritical CO₂ so as to extract desired compounds from the charge material.

15. The extraction apparatus of claim 7, wherein the digital computer further comprises saved parameters for each desired compound which is to be extracted from the charge material, and wherein the digital computer can operate the extraction apparatus using the saved parameters without the intervention of a human operator.

16. The extraction apparatus of claim 7, wherein the extraction apparatus comprises at least one collection vessel that can extract a compound by providing supercritical CO₂ at a pressure

17. The extraction apparatus of claim 7, wherein the extraction apparatus comprises more than one collection vessel, and wherein each collection vessel can independently extract a different compound by providing supercritical CO₂ at different pressures and/or temperatures.

18. The extraction apparatus of claim 7, wherein the extraction apparatus comprises a CO₂ recycle stage which removes compounds that were not extracted from the charge material from the CO₂ before returning the CO₂ to the chiller.

19. An extraction apparatus comprising:
a supply of CO₂, a chiller, a liquid displacement pump, a heater, an extraction vessel, a collection vessel, a CO₂ recycle stage, and a digital computer, wherein the collection vessel includes an outlet flow controller nut.
